(19) United States
(12) Patent Application Publication
(10) Pub. No.: US 2025/0037733 A1
(43) Pub. Date: Jan. 30, 2025

(54) DISCONTINUOUS NOISE REMOVAL IN AN AUDIO PROCESSING PIPELINE

(71) Applicant: Cisco Technology, Inc., San Jose, CA (US)

(72) Inventors: Chamran MoradiAshour, Stockholm (SE); Samir Ouelha, Suresnes (FR)

(21) Appl. No.: 18/360,936

(22) Filed: Jul. 28, 2023

(51) Int. Cl. G10L 25/21; G10L 25/84; H04M 9/08

(52) U.S. Cl. CPC G10L 25/21; G10L 25/84; H04M 9/082

(57) ABSTRACT

A method comprises: detecting audio to produce audio frames; detecting whether voice is continuously present across multiple consecutive ones of the audio frames based on voice activity detection performed on the audio frames; computing a signal-to-noise ratio (SNR) of an audio frame of the audio frames; determining whether to bypass or not bypass background noise removal (BNR) on the audio frame based on whether the voice is continuously present and the SNR; upon determining to bypass the BNR, bypassing the BNR on the audio frame, and first encoding the audio frame to produce a first encoded audio frame; upon determining to not bypass the BNR, performing the BNR on the audio frame to produce a reduced-noise audio frame, and second encoding the reduced-noise audio frame to produce a second encoded audio frame; and transmitting the first encoded audio frame or the second encoded audio frame.

### TECHNICAL FIELD

The present disclosure relates generally to audio processing.

### BACKGROUND

Audio collaboration or conference applications offer different audio modes. Some of the audio modes implement background noise removal (BNR) technology/techniques (referred to simply as “BNR”) to remove background noise from audio captured in a room. BNR may employ a deep learning algorithm to remove the background noise. While effective at removing the background noise, the BNR is computationally complex and greatly increases central processing unit (CPU) utilization. This can be problematic in battery powered mobile devices that have limited CPU capacity and limited battery power.

### BRIEF DESCRIPTION OF THE DRAWINGS

FIG. 1 is a block diagram of a network environment in which discontinuous noise removal (DNR) may be implemented, according to an example embodiment.

FIG. 2 is a block diagram of an audio processing pipeline of a sender-side endpoint in the network environment, according to an example embodiment.

FIG. 3 is an illustration of a DNR module employed in the audio processing pipeline, according to an example embodiment.

FIG. 4 is a block diagram of a voice activity detector (VAD) stabilizer of the DNR module, according to an embodiment.

FIG. 5 is a flowchart of a method of performing DNR, according to an example embodiment.

FIG. 6 illustrates a hardware block diagram of a computing device that may perform functions associated with operations discussed herein, according to an example embodiment.

### DETAILED DESCRIPTION

### Overview

In an embodiment, a method comprises: detecting audio to produce audio frames; detecting whether voice is continuously present across multiple consecutive ones of the audio frames based on voice activity detection performed on the audio frames; computing a signal-to-noise ratio (SNR) of an audio frame of the audio frames; determining whether to bypass or not bypass background noise removal (BNR) on the audio frame based on whether the voice is continuously present and the SNR; upon determining to bypass the BNR, bypassing the BNR on the audio frame, and first encoding the audio frame to produce a first encoded audio frame; upon determining to not bypass the BNR, performing the BNR on the audio frame to produce a reduced-noise audio frame, and second encoding the reduced-noise audio frame to produce a second encoded audio frame; and transmitting the first encoded audio frame or the second encoded audio frame.

### EXAMPLE EMBODIMENTS

Embodiments presented herein are directed to discontinuous noise removal (DNR) in an audio pipeline of an endpoint. The DNR reduces the complexity and computational burden of audio background noise removal (BNR) performed on audio frames during a collaboration session without sacrificing performance, and improves a user experience during the collaboration session. The DNR leverages the fact that the BNR may be bypassed during silent speech segments and/or inaudible background noise, to reduce instances in which the BNR is employed. The DNR includes a decision unit (DU) that dynamically determines whether the BNR should be enabled or bypassed for each audio frame. The decision unit makes the determination based on voice activity detection (VAD) that is performed on each audio frame, stabilization of the VAD, a signal-to-noise ratio (SNR) for each audio frame, and an energy of each audio frame. Further features and advantages are presented below.

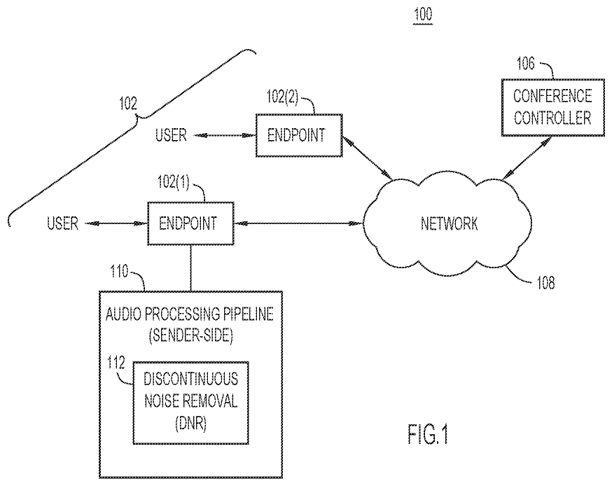

FIG. 1 is a block diagram of an example network environment 100 in which DNR may be implemented. Network environment 100 includes an endpoint 102(1), an endpoint 102(2), and a conference controller 106 each connected to, and configured to communicate over, a network 108. Endpoints 102(1), 102(2) (collectively referred to as “endpoints 102,” and which may also be referred to as “endpoint devices”) are respectively deployed in acoustic environments (e.g., rooms) and are operated by local users. Endpoints 102 may be wired and/or wireless communication devices, such as, but not limited to laptops or tablet computers, smartphones, dedicated teleconference systems, and the like. Under control of conference controller 106, endpoints 102 establish a teleconference collaboration session (e.g., an audio-video conference) with each other over network 108, which may include one or more wide area networks (WANs), such as the Internet, and one or more local area networks (LANs). During the collaboration session, endpoints 102 exchange audio and video packets as data packets (e.g., Internet Protocol (IP) packets or the like) over network 108 using any know or hereafter developed communication protocols, such as the transmission control protocol (TCP)/IP.

In a transmit or sending direction, endpoint 102(1) (acting as the “sender-side” endpoint) employs an audio processing pipeline 110 of the sender-side to capture/detect audio content (referred to simply as “audio”) that may include audio background noise (referred to simply as “background noise”) from the acoustic environment in which the endpoint is deployed to produce audio frames that include the background noise and possibly voice/speech from local talkers. Audio processing pipeline 110 processes the audio frames to produce encoded audio, and transmits the encoded audio to network 108. According to embodiments presented herein, audio processing pipeline 110 includes a DNR module 112. DNR module 112 performs background noise removal (BNR), selectively, on each of the audio frames under audio conditions that derive the most benefit from the BNR, or bypasses the BNR completely under second audio conditions that derive less benefit from the BNR (or under which the BNR is deemed unnecessary). By selectively limiting the use of the BNR on the audio frames, DNR module 112 reduces the computational burden on audio processing pipeline 110. As used herein, the terms “voice” and “speech” are synonymous and may be used interchangeably.

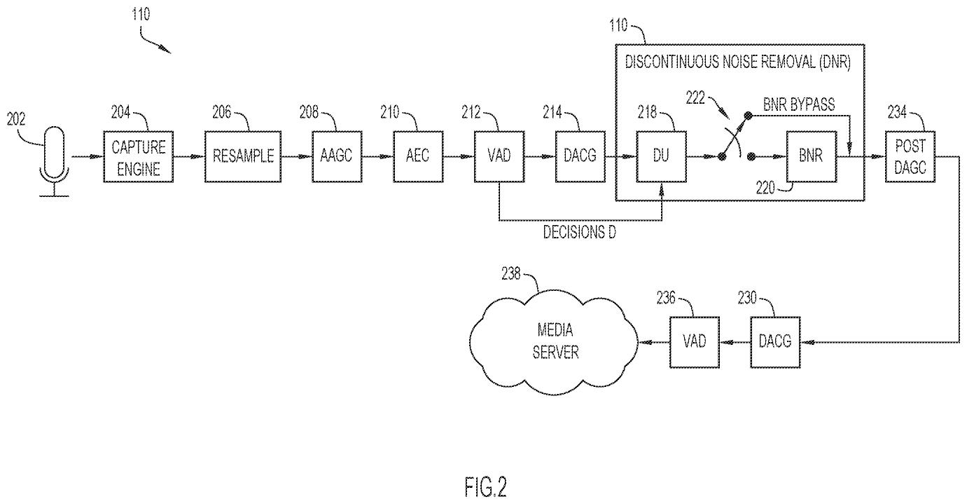

FIG. 2 is a block diagram of audio processing pipeline 110 according to an embodiment. A microphone 202 captures/detects audio energy from an acoustic environment, such as a room, to produce detected audio, and provides the detected audio to a capture engine 204 followed by a resample module 206. The detected audio may include background noise from the room and may also include voice/speech energy originated by one or more talkers in the room. Capture engine 204 and resample module 206 format the detected audio into a sequence of analog audio frames and provide the same to an analog automatic gain control (AAGC) module 208 followed by an acoustic echo canceler (AEC) 210. AAGC module 208 and AEC 210 perform analog automatic gain control and acoustic echo canceling on the analog audio frames to produce echo-canceled analog audio frames, and provide the same to frame-based voice activity detection (VAD) 212 (referred to simply as “VAD 212”).

VAD 212 digitizes the echo canceled analog audio frames to produce a sequence of digitized audio frames (referred to simply as “audio frames”) of audio samples, performs frame-based VAD on the sequence of audio frames to detect whether speech is present or is not present in each audio frame, and generates a 2-state decision D (also referred to as “decisions D” in the plural) that indicates either that voice is present/detected or that voice is not present/detected in each audio frame (i.e., one decision per audio frame). VAD 212 passes the audio frames to digital AGC (DAGC) module 214. DAGC module performs digital AGC on the audio frames to produce the audio frames in gain controlled form, and provides the same to DNR module 112.

DNR module 112 includes a decision unit (DU) 218, BNR 220, and a bypass switch 222 that provides a selectable bypass path around the BNR. DU 218 receives decisions D from VAD 212 and the audio frames from DAGC module 214. DU 218 makes energy and signal-to-noise ratio (SNR) measurements on each of the audio frames. DU 218 includes decision logic to determine, on a frame-by-frame basis, whether to apply BNR 220 to the current audio frame or to bypass the BNR on the current audio frame (i.e., not to perform the BNR) based on the decisions D and the energy and the SNR measurements. Generally, the decision logic of DU 218 determines to apply BNR 220 to the current audio frame when it includes an audible level of background noise, and determines not to apply the BNR to the current audio frame when it does not include the audible level of background noise. Upon determining to apply BNR 220, DU 218 closes bypass switch 222 to direct the current audio frame to the BNR, which performs the BNR on the current audio frame to produce a reduced-noise current audio frame, and provides the same to an output of DNR module 112. In this case, the reduced-noise current audio frame includes little or no background noise as originally detected by microphone 202.

On the other hand, upon determining to bypass BNR 220, DU 218 configures bypass switch 222 to bypass the BNR, in which case the current audio frame bypasses the BNR completely and is passed directly to the output of DNR module 112. In this case, the current audio frame represents an audio frame that bypassed BNR 220. As used herein, terms such as “turn on BNR” for an audio frame, “enable BNR” for the audio frame, “apply BNR” to the audio frame, and “perform BNR” on the audio frame are all synonymous and may be used interchangeable. Similarly, terms such as “bypass BNR” for an audio frame, “turn off BNR” for the audio frame, “disable BNR” for the audio frame, “not apply BNR” to the audio frame, and “not perform BNR” on the audio frame are all synonymous and may be used interchangeably.

As a result of the above-described operations, DNR module 112 provides a sequence of reduced-noise audio frames that did not bypass BNR 220 and audio frames that bypassed the BNR (depending on the determinations made by the DNR module as described above) to audio encoder 230 through post DAGC 234. Audio encoder 230 encodes the reduced-noise audio frames into encoded reduced-noise audio frames, encodes the audio frames that bypassed BNR 220 into encoded audio frames, and provides the same to a transport stage 236. Transport stage 236 formats the encoded reduced-noise audio frames and the audio frames that bypassed BNR 220 into transmit audio frames and transmits the same to media server 238 (e.g., conference controller 106) over network 108.

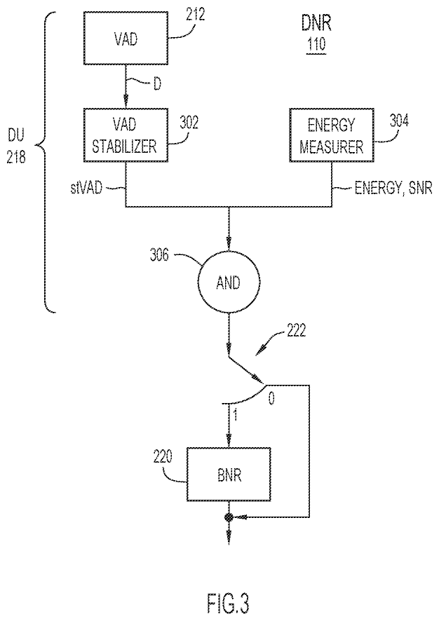

FIG. 3 is an illustration of DNR module 112 expanding primarily on DU 218, according to an example embodiment. As shown in FIG. 3, DU 218 includes a VAD stabilizer 302, an energy measurer 304, and decision/comparison logic 306. In the example of FIG. 3, DU 218 also includes VAD 212, although in other arrangements VAD 212 may be external to the DU. VAD 212 may employ deep learning-based VAD to determine whether each audio frame includes speech content or does not include the speech content. In some applications, VAD 212 may be used as “mute detection” provide a notification that a user is speaking (i.e., a talker), but muted, during a collaboration session.

VAD 212 generally operates with a high accuracy; however, in challenging environments, such as a noisy environment, the VAD can mistakenly detect the presence of speech in a current audio frame when speech is not actually present. Moreover, VAD 212 may produce decisions D that are too dynamic over a short period of time, i.e., the decisions D may change too abruptly from one audio frame to a next audio frame. Turning BNR 220 on and off on the audio frames (i.e., applying BNR to the audio frames or bypassing the BNR) incorrectly or too quickly responsive to incorrect or abruptly-changing decisions D can degrade an overall user listening experience during a collaboration session. Accordingly, DU 218 employs VAD stabilizer 302 to stabilize decisions D in order to mitigate the aforementioned undesired effects, as described below.

Speech utterances include small segments of silence which can cause VAD 212 to switch on and off too abruptly (i.e., to produce decisions D that transition too abruptly from indicating that speech is present, to speech is not present, and then back to speech is present). To avoid such changes from enabling/disabling BNR 220 too abruptly, VAD stabilizer 302 stabilizes decisions D, to produce “stabilized VAD” as an indication of whether “voice is continuously present” (i.e., “stable”) across multiple (which may include a predetermined number of) contiguous/consecutive audio frames.

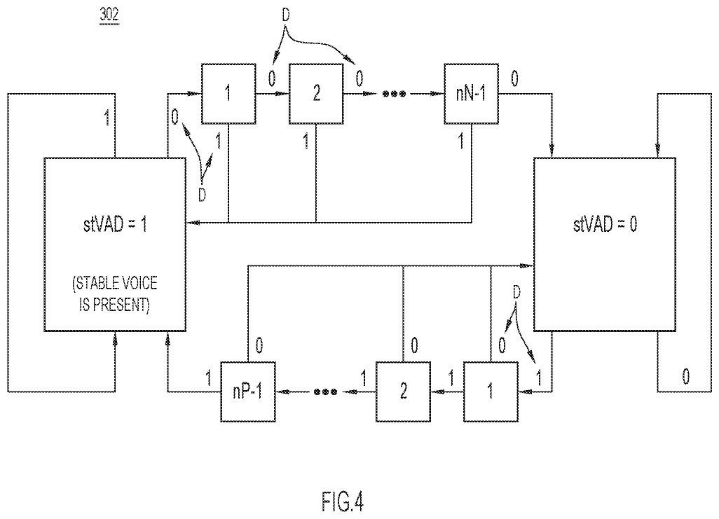

FIG. 4 shows VAD stabilizer 302 according to an embodiment. In the example of FIG. 4, VAD stabilizer 302 is implemented as a state machine. VAD stabilizer 302 receives decisions D from VAD 212 frame-by-frame, and processes the decisions D frame-by-frame. The example of FIG. 4 assumes that each decision D for each (i.e., current) audio frame is in one of the following 2 states: “1” when VAD 212 detects speech in the current audio frame (i.e., indicates that speech is present in the current audio frame); and “0” when VAD 212 does not detect speech in the current audio frame (i.e., indicates that speech is not present in the current audio frame).

VAD stabilizer 302 operates primarily in 2 stabilized VAD states 1 and 0, shown as 2 large rectangles at left and right sides of FIG. 4, respectively. The stabilized state (stVAD) of VAD stabilizer 302 represents an output of the VAD stabilizer. Stabilized VAD state=1 indicates that voice is stable (i.e., is continuously present) across multiple consecutive/contiguous audio frames as indicated by decision D, while stabilized VAD state=0 indicates that voice is not stable (i.e., is not continuously present across multiple consecutive/contiguous audio frames). When decision D (e.g., D=0 or 1) for the current audio frame is the same as the stabilized VAD state (e.g., stVAD=0 or 1), the stabilized VAD state remains unchanged (i.e., the same). On the other hand, when decision D (e.g., D=0 or 1) for the current audio frame is different from the stabilized VAD state (e.g., stVAD=1 or 0), VAD stabilizer 302 accumulates decisions D for subsequent consecutive audio frames and, when a sufficient consecutive number of similar decisions D accrue, the VAD stabilizer switches the existing stabilized VAD state to the other/alternative/opposite stabilized VAD state. Specifically, (i) when the (starting) stabilized VAD state=1, VAD stabilizer 302 accumulates nN consecutive 0 decisions D (from n previous audio frames) before switching to stabilized VAD state=0, and (ii) when the (starting) stabilized VAD state=0, the VAD stabilizer accumulates nP consecutive 1 decisions D (from n previous audio frames) before switching to stabilized VAD state=1.

In practice nP may be small (e.g., 3 frames) in order to allow VAD stabilizer 302 to react quickly to detect speech from a state in which the VAD stabilizer is indicating that speech is not stable, while nN can be much larger so that the variability of the VAD stabilization can be decreased. In other words, to have nP small and nN large may lead to detecting more audio frames as speech containing audio frames, and thus the small segments of silence during a collaboration session may be detected as speech containing audio frames.

Returning to FIG. 3, energy measurer 304 measures/computes an energy of a complete spectrum of each audio frame (i.e., of the current audio frame) separately. The computed energy provides an indication of all types of energy or a total energy that may be conveyed in the current audio frame, including noise, speech, or noisy speech. Energy measurer 304 may compute a discrete Fourier transform (DFT) of the current audio frame to produce a DFT representation of the current audio frame, or may simply receive the DFT representation from a previous module of audio processing pipeline 110. Energy measurer 304 may compute the energy Eₓ (also referred to as a “full-spectrum energy”) of the complete spectrum of the current audio frame based on the following equation:

$${E}_{x} = {\sum }_{k = 0}^{N / 2} {\vert X ( k ) \vert}^{2} ,$$

where X(k) is the DFT representation of the current audio frame, k is an index of each frequency bin of the DFT representation, and N is a length of the spectrum of the current audio frame.

Due to the symmetry of the DFT spectrum, and as the obtained energy may either be compared with an energy threshold or used in a ratio equation (described below), mirrored frequencies from

$$\frac{N}{2} + 1 to N - 1$$

are excluded from the energy computation. As described below, Energy Eₓ is compared against an energy threshold Eₜₕᵣ to detect whether the current audio frame is silent (i.e., does not include speech) or not.

Energy measurer 304 also computes an SNR of the current audio frame as follows. First, energy measurer 304 computes an energy (i.e., an energy level) of a noise floor of the current audio frame Eₓ_{ₙₒᵢₛₑ}. To do this, energy measurer 304 finds peaks of the frequency spectrum of the current audio frame using a “peak picking” method, and defines a set of frequency bins that correspond to the detected peaks in the current audio frame as:

$$S P = \{ p \} p = 1 , 2 , … , {N}_{npeaks} .$$

Next, energy measurer 304 computes the energy of the noise floor Eₓ_{ₙₒᵢₛₑ} according to:

$${E}_{{x}_{noise}} = {\sum }_{k ∉ S P} {\vert X ( k ) \vert}^{2} .$$

The above computation excludes energy from the frequency bins that include the peaks. Next, the SNR of the current audio frame is computed as a ratio of (i) full-spectrum energy Eₓ of the current audio frame, to (ii) the noise floor energy Eₓ_{ₙₒᵢₛₑ} of the current audio frame, as follows:

$$SNR = {E}_{x} / {E}_{{x}_{noise}} .$$

The SNR is compared to a threshold SNRₜₕᵣ to determine whether the background noise is audible or not, as described further below.

DU 218 includes decision/comparison logic 306 to determine whether to enable or disable BNR 220 for the current audio frame based on a combination of the aforementioned parameters, including the stabilized VAD state (stVAD), the energy Eₓ, the energy threshold Eₜₕᵣ, the SNR, and the SNR threshold SNRₜₕᵣ. The decision “DU” made by DU 218 to enable/apply or disable/bypass BNR 220 for the current audio frame can be defined by the following set of logical relationships:

$$D U = \{ \begin{matrix}0 , ( bypass ) & stVAD = 0 and {E}_{x} < {E}_{thr} . \\ 1 , & stVAD = 1 and SNR < {SNR}_{thr} . \\ 0 , ( bypass ) & stVAD = 1 and SNR > {SNR}_{thr} .\end{matrix}$$

For DU=1, BNR is enabled and for DU=0 BNR is bypassed.

According to the logic above:
a. DNR module 112 determines to bypass BNR 220 when the voice is not continuously present across the predetermined number of consecutive audio frames (e.g., stVAD=0) and the energy Eₓ is less than the energy threshold Eₜₕᵣ. In this case, the background noise may be at a level that is sufficiently low to be inaudible to a human listener.
b. DNR module 112 determines to not bypass the BNR when the voice is continuously present across the predetermined number of consecutive audio frames (e.g., stVAD=1) and the SNR is less than the SNR threshold SNRₜₕᵣ. In this case, the background noise may be at a level that is sufficiently high to be audible to the human listener.
c. DNR module 112 determines to bypass BNR 220 when the voice is continuously present (e.g., stVAD=1) and the SNR exceeds the SNR threshold SNRₜₕᵣ. In this case, the background noise may be at the level that is sufficiently low to be inaudible to the human listener.

The embodiments presented herein include or rely on one or more of the following features:
a. Based on criteria related to an SNR estimated using past audio frames and a current audio frame, a decision can be made as to how strong background noise is in the audio frames.
b. Based on VAD, there is useful information about whether the current audio frame contains speech or not.
c. Based on an energy of the current audio frame, it can be decided whether the current audio frame is silent or not. In the case of a silent frame, an audio coder-decoder (“codec”) does not send any speech packets to a far-end endpoint. Instead, comfort noise is generated in the receiver side.
d. Because it is important not to bypass the BNR when it is most helpful, a decision on whether to bypass the BNR is based on multiple computed energy-based factors as mentioned above, as well as stabilizing VAD using VAD stabilization.

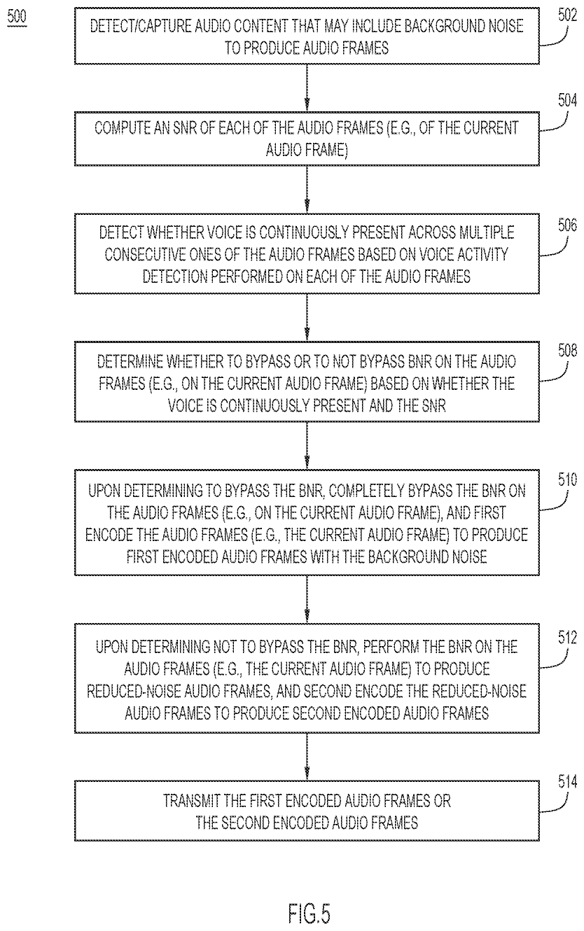

FIG. 5 is a flowchart of an example method 500 of performing DNR in an endpoint that includes a sender-side audio processing pipeline (also referred to simply as an “audio processing pipeline”). Operations of method 500 are described above.

At 502, a microphone of the audio processing pipeline detects/captures audio content (referred to simply as “audio”) that may include background noise, and the audio pipeline converts the detected audio to audio frames that include the background noise, when present. The DNR performs next operations 504-514 for a current audio frame as described below, repeats the operations for the next audio frame, and so on.

At 504, a DNR module of the audio processing pipeline computes an SNR of each of the audio frames (e.g., on the current audio frame). In an example, the DNR module computes a full-spectrum energy and an energy of a noise floor of each of the audio frames, and computes the SNR as a ratio of the full-spectrum energy and the SNR.

At 506, the DNR module detects whether voice is continuously present across multiple contiguous/consecutive ones of the audio frames (e.g., which may precede and/or include the current audio frame), or based on voice activity detection performed on the audio frames.

At 508, the DNR determines whether to bypass BNR on each of the audio frames (e.g., on the current audio frame) or not bypass the BNR based on whether the voice is continuously present and the SNR.

At 510, upon determining to bypass the BNR, the DNR completely bypasses the BNR on the audio frames (e.g., on the current audio frame). The audio processing pipeline includes an audio encoder that first encodes the audio frames (e.g., first encodes the current audio frame) to produce first encoded audio frames (with the background noise) (e.g., to produce a first encoded audio frame).

At 512, upon determining to not bypass the BNR, the DNR performs the BNR on the audio frames (e.g., on the current audio frame) to produce reduced-noise audio frames (e.g., a reduced noise audio frame). In some embodiments, echo-canceling may be performed on the audio frames prior to performing the BNR. The audio encoder second encodes the reduced-noise audio frames (e.g., the current audio frame) to produce second encoded audio frames (e.g., a second encoded audio frame). In an example, the encoder may employ the same encoding process to perform the first encode operation and the second encode operation, but the encoder may perform the first encode operation and the second encode operation at different times on respective audio frames that have bypassed the BNR, or have not bypassed the BNR.

At 514, the audio processing pipeline transmits the first encoded audio frames (e.g., the first encoded audio frame) or the second encoded audio frames (e.g., the second encoded audio frame) (whichever type of encoded frames are delivered by the DNR).

The operations described above are performed on a frame-by-frame basis, i.e., on/for each audio frame.

In other embodiments, the DNR may be implemented in an audio decode pipeline of the endpoint.

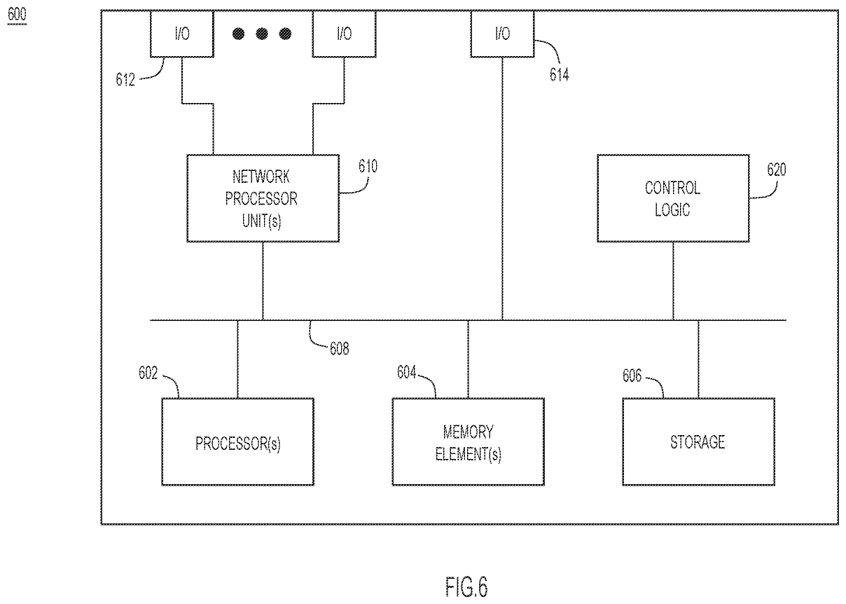

Referring to FIG. 6, FIG. 6 illustrates a hardware block diagram of a computing device 600 that may perform functions associated with operations discussed herein in connection with the techniques depicted in FIGS. 1-5. In various embodiments, a computing device or apparatus, such as computing device 600 or any combination of computing devices 600, may be configured as any entity/entities as discussed for the techniques depicted in connection with FIGS. 1-5 in order to perform operations of the various techniques discussed herein. For example, computing device 600 may represent each of endpoints 102.

In at least one embodiment, the computing device 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X. Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In some aspects, the techniques described herein relate to a method including: detecting audio to produce audio frames; detecting whether voice is continuously present across multiple consecutive ones of the audio frames based on voice activity detection performed on the audio frames; computing a signal-to-noise ratio (SNR) of an audio frame of the audio frames; determining whether to bypass or not bypass background noise removal (BNR) on the audio frame based on whether the voice is continuously present and the SNR; upon determining to bypass the BNR, bypassing the BNR on the audio frame, and first encoding the audio frame to produce a first encoded audio frame; upon determining to not bypass the BNR, performing the BNR on the audio frame to produce a reduced-noise audio frame, and second encoding the reduced-noise audio frame to produce a second encoded audio frame; and transmitting the first encoded audio frame or the second encoded audio frame.

In some aspects, the techniques described herein relate to a method, wherein: determining to bypass the BNR includes determining to bypass the BNR when the voice is continuously present and the SNR exceeds an SNR threshold.

In some aspects, the techniques described herein relate to a method, further including: computing an energy of the audio frame, wherein determining to bypass the BNR further includes determining to bypass the BNR when the voice is not continuously present and the energy exceeds an energy threshold.

In some aspects, the techniques described herein relate to a method, wherein: determining to not bypass the BNR includes determining to not bypass the BNR when the voice is continuously present and the SNR is less than an SNR threshold.

In some aspects, the techniques described herein relate to a method, further including: computing full-spectrum energy of the audio frame; computing an energy of a noise floor of the audio frame; and computing the SNR as a ratio of the full-spectrum energy of the audio frame to the energy of the noise floor of the audio frame.

In some aspects, the techniques described herein relate to a method, further including: echo-canceling the audio frame to produce an echo-canceled audio frame that include prior to performing the BNR, performing first encoding, and performing second encoding.

In some aspects, the techniques described herein relate to a method, further including: performing the voice activity detection on the audio frames to produce decisions that indicate that the voice is present or that the voice is not present for the audio frames; and detecting that the voice is continuously present when the decisions include a first number of consecutive decisions, which all indicate that the voice is present.

In some aspects, the techniques described herein relate to a method, further including: detecting that the voice is not continuously present when the decisions include a second number of consecutive decisions, which all indicate that the voice is not present.

In some aspects, the techniques described herein relate to a method, wherein the first number of consecutive decisions is less than the second number of consecutive decisions.

In some aspects, the techniques described herein relate to an apparatus including: one or more network processor units to communicate with devices in a network; and a processor coupled to the one or more network processor units and configured to perform: receiving audio frames; detecting whether voice is continuously present across multiple consecutive ones of the audio frames based on voice activity detection performed on the audio frames; computing a signal-to-noise ratio (SNR) of an audio frame of the audio frames; determining whether to bypass or not bypass background noise removal (BNR) on the audio frame based on whether the voice is continuously present and the SNR; upon determining to bypass the BNR, bypassing the BNR on the audio frame, and first encoding the audio frame to produce a first encoded audio frame; upon determining to not bypass the BNR, performing the BNR on the audio frame to produce a reduced-noise audio frame, and second encoding the reduced-noise audio frame to produce a second encoded audio frame; and transmitting the first encoded audio frame or the second encoded audio frame.

In some aspects, the techniques described herein relate to an apparatus, wherein: the processor is configured to perform determining to bypass the BNR by determining to bypass the BNR when the voice is continuously present and the SNR exceeds an SNR threshold.

In some aspects, the techniques described herein relate to an apparatus, wherein the processor is further configured to perform: computing an energy of the audio frame, wherein the processor is further configured to perform determining to bypass the BNR by determining to bypass the BNR when the voice is not continuously present and the energy exceeds an energy threshold.

In some aspects, the techniques described herein relate to an apparatus, wherein: the processor is configured to perform determining to not bypass the BNR by determining to not bypass the BNR when the voice is continuously present and the SNR is less than an SNR threshold.

In some aspects, the techniques described herein relate to an apparatus, wherein the processor is further configured to perform: computing full-spectrum energy of the audio frame; computing an energy of a noise floor of the audio frame; and computing the SNR as a ratio of the full-spectrum energy of the audio frame to the energy of the noise floor of the audio frame.

In some aspects, the techniques described herein relate to an apparatus, wherein the processor is further configured to perform: the voice activity detection on the audio frames to produce decisions that indicate that the voice is present or that the voice is not present for the audio frames; and detecting that the voice is continuously present when the decisions include a first number of consecutive decisions, which all indicate that the voice is present.

In some aspects, the techniques described herein relate to an apparatus, wherein the processor is further configured to perform: detecting that the voice is not continuously present when the decisions include a second number of consecutive decisions, which all indicate that the voice is not present.

In some aspects, the techniques described herein relate to an apparatus, wherein the first number of consecutive decisions is less than the second number of consecutive decisions.

In some aspects, the techniques described herein relate to a non-transitory computer readable medium encoded with instructions that, when executed by a processor, cause the processor to perform: receiving audio frames; detecting whether voice is continuously present across multiple consecutive ones of the audio frames based on voice activity detection performed on the audio frames; computing a signal-to-noise ratio (SNR) of an audio frame of the audio frames; determining whether to bypass or not bypass background noise removal (BNR) on the audio frame based on whether the voice is continuously present and the SNR; upon determining to bypass the BNR, bypassing the BNR on the audio frame, and first encoding the audio frame to produce a first encoded audio frame; upon determining to not bypass the BNR, performing the BNR on the audio frame to produce a reduced-noise audio frame, and second encoding the reduced-noise audio frame to produce a second encoded audio frame; and transmitting the first encoded audio frame or the second encoded audio frame.

In some aspects, the techniques described herein relate to a non-transitory computer readable medium, wherein: the instructions to cause the processor to perform determining to bypass the BNR include instructions to cause the processor to perform determining to bypass the BNR when the voice is continuously present and the SNR exceeds an SNR threshold.

In some aspects, the techniques described herein relate to a non-transitory computer readable medium, further including instructions to cause the processor to perform: computing an energy of the audio frame, wherein the instructions to cause the processor to perform determining to bypass the BNR include instructions to cause the processor to perform determining to bypass the BNR when the voice is not continuously present and the energy exceeds an energy threshold.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting audio to produce audio frames;
detecting whether voice is continuously present across multiple consecutive ones of the audio frames based on voice activity detection performed on the audio frames;
computing a signal-to-noise ratio (SNR) of an audio frame of the audio frames;
determining whether to bypass or not bypass background noise removal (BNR) on the audio frame based on whether the voice is continuously present and the SNR;
upon determining to bypass the BNR, bypassing the BNR on the audio frame, and first encoding the audio frame to produce a first encoded audio frame;
upon determining to not bypass the BNR, performing the BNR on the audio frame to produce a reduced-noise audio frame, and second encoding the reduced-noise audio frame to produce a second encoded audio frame; and
transmitting the first encoded audio frame or the second encoded audio frame.

2. The method of claim 1, wherein:
determining to bypass the BNR includes determining to bypass the BNR when the voice is continuously present and the SNR exceeds an SNR threshold.

3. The method of claim 2, further comprising:
computing an energy of the audio frame,
wherein determining to bypass the BNR further includes determining to bypass the BNR when the voice is not continuously present and the energy exceeds an energy threshold.

4. The method of claim 1, wherein:
determining to not bypass the BNR includes determining to not bypass the BNR when the voice is continuously present and the SNR is less than an SNR threshold.

5. The method of claim 1, further comprising:
computing full-spectrum energy of the audio frame;
computing an energy of a noise floor of the audio frame; and
computing the SNR as a ratio of the full-spectrum energy of the audio frame to the energy of the noise floor of the audio frame.

6. The method of claim 1, further comprising:
echo-canceling the audio frame to produce an echo-canceled audio frame that include prior to performing the BNR, performing first encoding, and performing second encoding.

7. The method of claim 1, further comprising:
performing the voice activity detection on the audio frames to produce decisions that indicate that the voice is present or that the voice is not present for the audio frames; and
detecting that the voice is continuously present when the decisions include a first number of consecutive decisions, which all indicate that the voice is present.

8. The method of claim 7, further comprising:
detecting that the voice is not continuously present when the decisions include a second number of consecutive decisions, which all indicate that the voice is not present.

9. The method of claim 8, wherein the first number of consecutive decisions is less than the second number of consecutive decisions.

10. An apparatus comprising:
one or more network processor units to communicate with devices in a network; and
a processor coupled to the one or more network processor units and configured to perform:
receiving audio frames;
detecting whether voice is continuously present across multiple consecutive ones of the audio frames based on voice activity detection performed on the audio frames;
computing a signal-to-noise ratio (SNR) of an audio frame of the audio frames;
determining whether to bypass or not bypass background noise removal (BNR) on the audio frame based on whether the voice is continuously present and the SNR;
upon determining to bypass the BNR, bypassing the BNR on the audio frame, and first encoding the audio frame to produce a first encoded audio frame;
upon determining to not bypass the BNR, performing the BNR on the audio frame to produce a reduced-noise audio frame, and second encoding the reduced-noise audio frame to produce a second encoded audio frame; and
transmitting the first encoded audio frame or the second encoded audio frame.

11. The apparatus of claim 10, wherein:
the processor is configured to perform determining to bypass the BNR by determining to bypass the BNR when the voice is continuously present and the SNR exceeds an SNR threshold.

12. The apparatus of claim 11, wherein the processor is further configured to perform:
computing an energy of the audio frame,
wherein the processor is further configured to perform determining to bypass the BNR by determining to bypass the BNR when the voice is not continuously present and the energy exceeds an energy threshold.

13. The apparatus of claim 10, wherein:
the processor is configured to perform determining to not bypass the BNR by determining to not bypass the BNR when the voice is continuously present and the SNR is less than an SNR threshold.

14. The apparatus of claim 10, wherein the processor is further configured to perform:
computing full-spectrum energy of the audio frame;
computing an energy of a noise floor of the audio frame; and
computing the SNR as a ratio of the full-spectrum energy of the audio frame to the energy of the noise floor of the audio frame.

15. The apparatus of claim 10, wherein the processor is further configured to perform:
the voice activity detection on the audio frames to produce decisions that indicate that the voice is present or that the voice is not present for the audio frames; and
detecting that the voice is continuously present when the decisions include a first number of consecutive decisions, which all indicate that the voice is present.

16. The apparatus of claim 15, wherein the processor is further configured to perform:
detecting that the voice is not continuously present when the decisions include a second number of consecutive decisions, which all indicate that the voice is not present.

17. The apparatus of claim 16, wherein the first number of consecutive decisions is less than the second number of consecutive decisions.

18. A non-transitory computer readable medium encoded with instructions that, when executed by a processor, cause the processor to perform:
receiving audio frames;
detecting whether voice is continuously present across multiple consecutive ones of the audio frames based on voice activity detection performed on the audio frames;
computing a signal-to-noise ratio (SNR) of an audio frame of the audio frames;
determining whether to bypass or not bypass background noise removal (BNR) on the audio frame based on whether the voice is continuously present and the SNR;
upon determining to bypass the BNR, bypassing the BNR on the audio frame, and first encoding the audio frame to produce a first encoded audio frame;
upon determining to not bypass the BNR, performing the BNR on the audio frame to produce a reduced-noise audio frame, and second encoding the reduced-noise audio frame to produce a second encoded audio frame; and
transmitting the first encoded audio frame or the second encoded audio frame.

19. The non-transitory computer readable medium of claim 18, wherein:
the instructions to cause the processor to perform determining to bypass the BNR include instructions to cause the processor to perform determining to bypass the BNR when the voice is continuously present and the SNR exceeds an SNR threshold.

20. The non-transitory computer readable medium of claim 19, further comprising instructions to cause the processor to perform:
computing an energy of the audio frame,
wherein the instructions to cause the processor to perform determining to bypass the BNR include instructions to cause the processor to perform determining to bypass the BNR when the voice is not continuously present and the energy exceeds an energy threshold.
